(19) United States
(12) Patent Application Publication
(10) Pub. No.: US 2003/0094881 A1
(43) Pub. Date: May 22, 2003

(54) Micromechanical device with damped microactuator

(76) Inventors: John D. Grade, Mountain View, CA (US); John H. Jerman, Palo Alto, CA (US); Joseph D. Drake, Palo Alto, CA (US)

Correspondence Address: DORSEY & WHITNEY LLP, Suite 3400, Four Embarcadero Center, San Francisco, CA, 94111-4187, US

(21) Appl. No.: 09/876,203

(22) Filed: Jun. 6, 2001

Related U.S. Application Data
(60) Provisional application No. 60/209,558, filed on Jun. 6, 2000.

(51) Int. Cl. H02N 1/00

(52) U.S. Cl. 310/309

(57) ABSTRACT

A damped micromechanical device comprising a housing provided with an internal fluid-tight chamber and an electrically-driven microactuator disposed in the fluid-tight chamber. The microactuator has a movable structure capable of being moved between first and second positions at a resonant frequency. A damping fluid is disposed in the fluid-tight chamber for damping the movement of the movable structure at the resonant frequency.

### CROSS-REFERENCE TO RELATED APPLICATION

The application claims priority to U.S. provisional patent application Serial No. 60/209,558 filed Jun. 6, 2000, the entire content of which is incorporated herein by this reference.

### SCOPE OF THE INVENTION

The present invention relates generally to micromechanical devices and more particularly to damped micromechanical devices.

### BACKGROUND

Micromechanical devices have heretofore been provided, and include sensors such as accelerometers, angular rate sensors and gyroscopes and optical devices such as optical switches, scanners, interferometers and tunable filters. Each of such devices includes a moving structure supported by flexural elements and is thus a spring mass system having one or more mechanical resonant modes. These modal frequencies are typically estimated through the use of finite element analysis. A mechanical quality factor or Q, which is a measure of the damping associated with the motion of the part, can be associated with each of these resonant modes.

For micromechanical devices fabricated in materials such as silicon, silicon dioxide, silicon nitride, or metals such as aluminum or nickel, the inherent damping of the structural material itself is extremely low. For example, electrostatic microactuators manufactured using deep reactive ion etched (DRIE) techniques often have comb gaps on the order of ten microns and thus do not provide damping in air that is sufficient for using such microactuators as positionable actuators. As a result, such devices typically have measurements of the mechanical quality factor Q in a vacuum that are typically greater than 5,000 and are potentially susceptible to external vibration or shock, especially from disturbances closely matching the frequency of one of the mechanical resonant modes of the device. It is thus important to control the damping of micromechanical devices.

Although viscous damping of micromechanical devices occurs from the dissipation of energy resulting from the motion of fluid, such as air or liquid, in which the device resides, attempts to control the damping of such devices have been limited. For devices which operate at or near a mechanical resonance, such as some vibrational gyroscopes, it has been desirable to maximize the mechanical quality factor Q of the system by devising methods to package the devices in vacuum, thereby reducing the viscous damping due to air. Papers describing the effects of primarily air damping on a variety of micromechanical devices include: “Viscous Energy Dissipation in Laterally Oscillating Planar Microstructures: A Theoretical and Experimental Study”, by Y.-H. Cho, et. al., 1993 Proceedings IEEE Micro Electro Mechanical Systems Workshop, Feb, 1993, pp. 93-98, and “Evaluation of Energy Dissipation Mechanisms in Vibrational Microstructures”, by H. Hosaka, et. al., 1994 Proceedings IEEE Micro Electro Mechanical Systems Workshop, February 1994, pp. 193-195. Neither of these papers, however, contains recommendations for modifying the geometry or fluid properties to optimize the damping of a device.

Some micromechanical devices, such as sensors, have relatively limited mechanical motion and can thus be controlled by including structures with small gaps, typically on the micron scale, in the device. In this technique, called squeeze-film damping, motion of the part causes such a gap to open and close, resulting in a fluid such as air flowing in and out of the gap. One of the many papers describing the use of holes through a structure to modify the squeeze-film effect is “Circuit Simulation Model of Gas Damping in Microstructures with Nontrivial Geometries”, by T. Veijola, et. al., Proceedings of the 9^{th} Int. Conference on Solid-State Sensors and Actuators, Stockholm, June, 1995, pp. 36-39. Unfortunately, squeeze-film damping is not generally suitable for devices having greater than a few microns of motion.

A limited amount of work has been done with linear accelerometers by packaging them in a viscous liquid, such as a silicone oil, to minimize “ringing” caused by the response of the accelerometer to shock. The practical issues involved with using fluids other than air to control or adjust damping in micromechanical devices have been discussed. See, for example, “A Batch Fabricated Silicon Accelerometer”, by Lynn Roylance, IEEE Trans. Elec. Dev., Vol. ED-26, Dec., 1979, pp1911-1917. See also International Application No. PCT/N092/00085 having International Publication No. WO 92/20096 by T. Kvisteroy et al. entitled “Arrangement for Encasing a Functional Device, and a Process for the Production of the Same”. Neither of these publications, however, discuss the damping of actuators.

There is a need for a damped actuator. Unfortunately, none of the foregoing techniques has been used with actuators, and specifically with electrostatic actuators.

In general, it is an object of the present invention to provide a microactuator which is damped so as to control the resonant modes of the microactuator.

Another object of the invention is to provide a microactuator of the above character which is damped with a fluid other than air.

Another object of the invention is to provide a microactuator of the above character which is damped with a dielectric fluid.

Another object of the invention is to provide a microactuator of the above character which is damped with a liquid.

### SUMMARY OF THE INVENTION

The present invention provides a damped micromechanical device comprising a housing having an internal fluid-tight chamber and an electrically-driven microactuator disposed in the fluid-tight chamber. The microactuator has a movable structure capable ofbeing moved between first and second positions at a resonant frequency. A damping fluid is disposed in the fluid-tight chamber for damping the movement of the movable structure at the resonant frequency.

### BRIEF DESCRIPTION OF THE DRAWINGS

The accompanying drawings, which are somewhat schematic in some instances and are incorporated in and form a part of this specification, illustrate an embodiment of the invention and, together with the description, serve to explain the principles of the invention.

FIG. 1 is a perspective view of a micromechanical device with damped microactuator of the present invention.

FIG. 2 is a perspective view of the micromechanical device of FIG. 1 with the cover removed to show the microactuator therein.

FIG. 3 is a top plan view of the microactuator in the micromechanical device of FIG. 1.

FIG. 4 is a cross-sectional view of the microactuator of FIG. 3 taken along the line 4-4 of FIG. 3.

FIG. 5 is a graph of the normalized rotation of the microactuator of FIG. 3 as a function of the operation frequency for several embodiments of the micromechanical device of FIG. 1.

### DESCRIPTION OF THE INVENTION

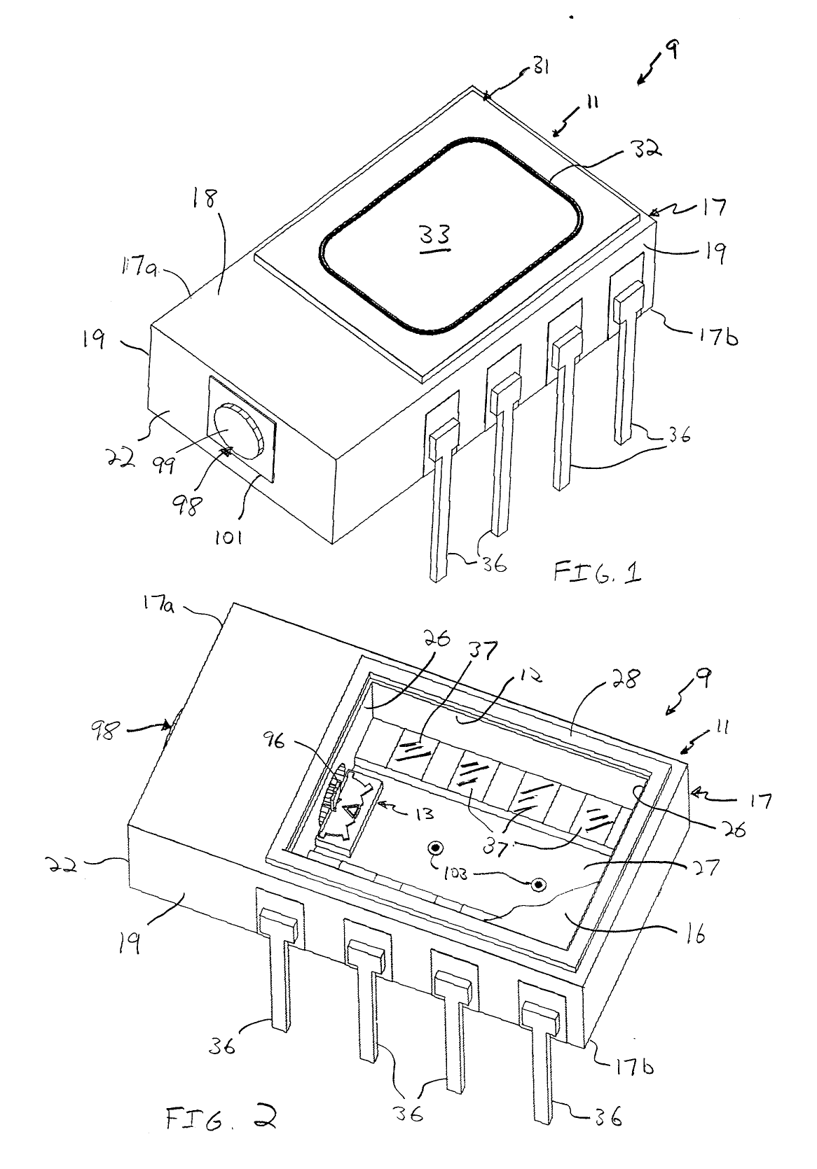

The micromechanical device of the present invention can be in the form of a device or package 9 having any suitable housing 11 provided with an internal fluid-tight chamber 12. A microactuator, and preferably an electrically-driven microactuator 13, is disposed in the chamber 12 (see FIGS. 1 and 2). A damping fluid 16 is disposed in the chamber 12 for reducing movements of the movable portion of microactuator 13 at the resonant frequency of the micro actuator.

Package 9 can preferably be similar to any of the conventional packages utilized for housing integrated circuits and other semiconductor devices. One embodiment of the package 9 is shown in FIGS. 1 and 2 and is similar to a conventional dual-inline integrated circuit package. Specifically, the housing 11 of package 9 has a main body 17 formed from any suitable material such as ceramic. Internal chamber 12 is formed in body 17, which has opposite first and second end portions 17a and 17b and is shown as having the shape of a parallelepiped. The body 17 has a planar top surface 18 interconnecting first and second opposite sides surfaces 19 and further includes a front surface 22 extending substantially perpendicular to surfaces 18 and 19. Chamber 12 extends downwardly from an opening 23 provided in top surface 18 and is formed, in part, by a forward surface 26 and a bottom surface 27. The forward surface 26 extends parallel to front surface 22 and perpendicular to bottom surface 27. A seal in the form of conventional sealing ring 28 is adhered or otherwise secured to top surface 18 around opening 23. The sealing ring 28 is made from any suitable materials such as gold.

Housing 11 further includes a cover 31 made from any suitable materials such as gold-plated Kovar. The cover sealably engages body 17, by means of sealing ring 28, at opening 23. Cover 31 or lid is preferably planar in conformation and extends over the ring 28 and opening 23. A corrugated-like flexible ring 32 is formed in cover 31 for providing a central portion 33 which can move inwardly and outwardly relative to opening 23 so as to accommodate expansion and compression of the fluid within the chamber 12. Lid 31 is secured to sealing ring 28 by any suitable means such as heat bonding.

Electrical interconnect means is included in package 9 for permitting electrical connections to be made with microactuator 13 carried within. In the illustrated embodiment of the package 9, such electrical interconnect means includes a plurality of conventional pins 36 spaced along each side surface 19 of body 17. Specifically, four pins 36 are provided on each side surface 19. It should be appreciated that the invention is broad enough to cover solder bumps and any other conventional means of the packaged integrated circuit art for making electrical contact with microactuator 13. Each pin 36 is electrically interconnected, for example by means of internal electrical leads (not shown), to a respective interconnect or bonding pad 37 disposed within chamber 12. In the embodiment illustrated, a plurality of spaced-apart bonding pads 37 are provided on bottom surface 27 within chamber 12.

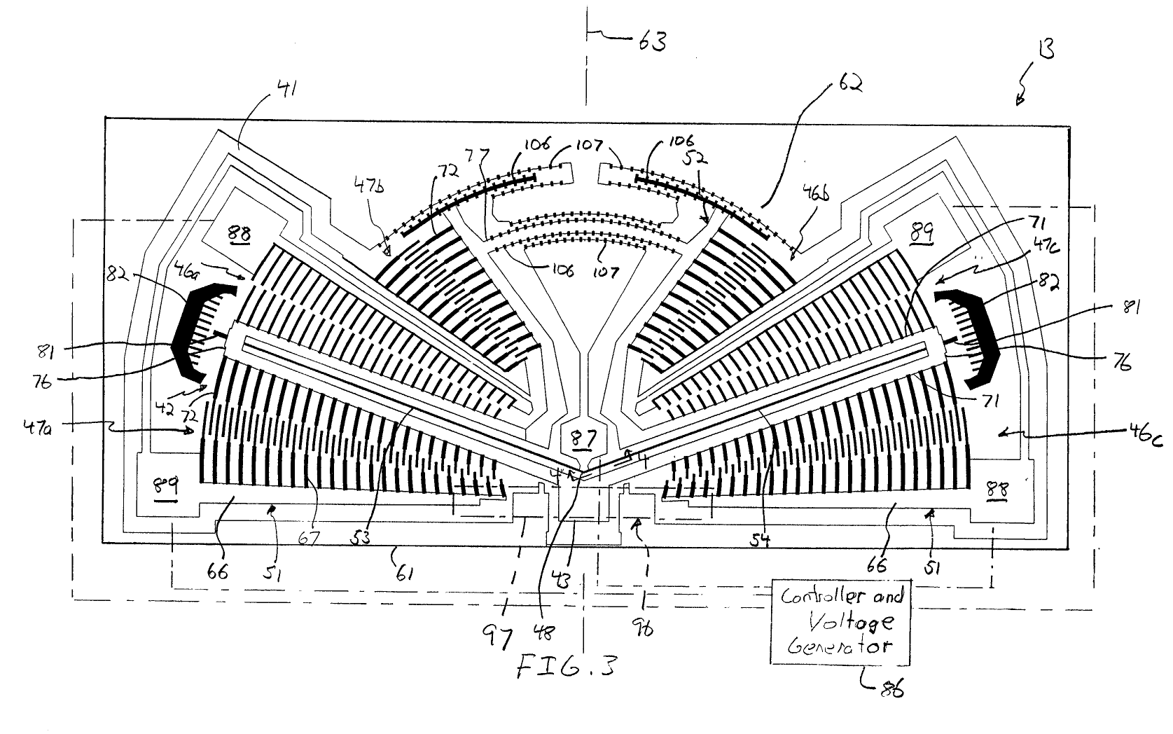

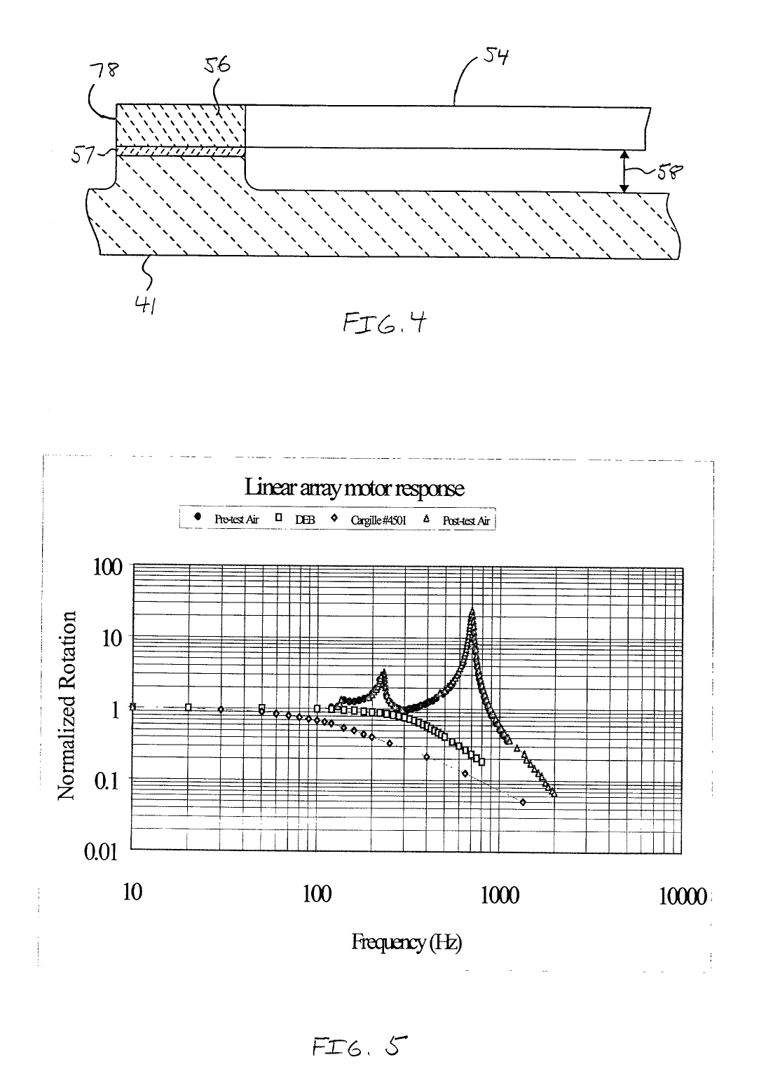

The electrically-driven microactuator 13 can be of any suitable type and is preferably an electromagnetic microactuator in which the movable portion of the microactuator is driven by electromagnetic forces. More preferably, the microactuator 13 is an electrostatic microactuator in which the movable portion of the microactuator is driven by electrostatic forces. Such electrostatic microactuator 13, in general, has similarities to the microactuators disclosed in U.S. patent application Ser. No. 09/464,361 filed Dec. 15, 1999 (Our file No. A-68185), U.S. patent application Ser. No. 09/547,698 filed Apr. 12, 2000 (Our file No. A-68187), U.S. patent application Ser. No. 09/727,794 filed Nov. 29, 2000 (Our file No. A-70055) and U.S. patent application Ser. No. 09/755,743 filed Jan. 5, 2001 (Our file No. A-70217), the entire content of each of which is incorporated herein by this reference. In this regard, microactuator 13 is formed on a planar substrate 41 and has a movable structure 42, which includes a mirror holder 43, that overlies substrate 41 (see FIGS. 3 and 4). At least one and as shown a plurality of first and second comb drive assemblies 46 and 47 are carried by substrate 41 for preferably rotating movable structure 42 in first and second opposite directions about an axis of rotation 48 extending perpendicular to planar substrate 41. The axis of rotation is shown as a point in FIG. 3 and labeled by reference line 48. Each of the first and second comb drive assemblies 46 and 47 includes a first drive member or comb drive member 51 mounted on substrate 41 and a second drive member or comb drive member 52 overlying the substrate. The movable structure 42 of rotary microactuator 13 includes second comb drives 52 and is supported or suspended above substrate 41 by first and second spaced-apart springs 43 and 44.

Substrate 41 is made from any suitable material such as silicon and is preferably formed from a silicon wafer. The substrate has a thickness ranging from 200 to 600 microns and preferably approximately 400 microns. Movable structure 42 and first and second springs 53 and 54 are formed atop the substrate 41 by a second or top layer 56 made from a wafer of any suitable material such as silicon (see FIG. 4). Top wafer 56 has a thickness ranging from 10 to 200 microns and preferably approximately 85 microns and is secured to substrate 41 by any suitable means. The top wafer is preferably fusion bonded to the substrate by means of a silicon dioxide layer 57, which further serves as an insulator between the conductive top wafer 56 and the conductive substrate 41. Top wafer 56 may be lapped and polished to the desired thickness. Movable structure 32 and first and second springs 53 and 54 are formed from top wafer 56 by any suitable means, and are preferably etched from the wafer 56 using deep reactive ion etching techniques. The movable structure 42 and springs 53 and 54 are spaced above substrate 41 by an air gap 58, shown in FIG. 4, that ranges from three to 30 microns and is preferably approximately 15 microns, so as to be electrically isolated from the substrate 41.

At least one and preferably a plurality of first comb drive assemblies 46 are included in rotary electrostatic microactuator 13 and disposed about axis of rotation 48 for driving movable structure 42 in a clockwise direction about the axis of rotation 48. At least one and preferably a plurality of second comb drive assemblies 47 are included in microactuator 13 for driving movable structure 42 in a counterclockwise direction about the axis of rotation 48. Each of the first and second comb drive assemblies 46 and 47 extends substantially radially from axis of rotation 48 and the assemblies 46 and 47, in the aggregate, subtend and angle ranging from 90 to 180 degrees and preferably approximately 180 degrees to provide a semicircular or fan-like shape to the microactuator 13. More particularly, microactuator 13 has three first comb drive assemblies 46a, 46b, and 46c and three second comb drive assemblies 47a, 47b, and 47c. The rotary microactuator 13 has abase 61 extending along a diameter of the semicircle formed by the microactuator and a substantially semicircular-shaped arc 62 forming the outer periphery of microactuator 13. A radial centerline 63 extends in the plane of substrate 41 perpendicular to base 61 and through axis of rotation 48. The first comb drive assemblies 46 are interspersed between the second comb drive assemblies 47, and the first comb drive assemblies 46 are symmetrically disposed relative to the second comb drive assemblies 47 about radial centerline 63. Mirror holder 43 is disposed at the center of microactuator 13 adjacent base 61.

First comb drive 51 of each of first and second comb drive assemblies 46 and 47 is mounted to substrate 41 by means of silicon dioxide layer 57. The first or stationary comb drives 51 are thus immovably secured to the substrate 41 and part of the stationary structure of microactuator 13. Each of the first comb drives 51 has a radial-extending bar 66 provided with a first or inner radial portion and a second or outer radial portion. Such stationary bars 66 each extend to the outer periphery 62 of the microactuator 13. A plurality of comb drive fingers or comb fingers 67 extend from one side of each bar 66 in longitudinally spaced-apart positions along the length of the bar at separation distances ranging from eight to 50 microns and preferably approximately 35 microns. First or movable comb fingers 67 extend substantially perpendicularly from bar 66 and are each preferably arcuate in shape. In a preferred embodiment, piecewise linear segments are used to form the comb fingers 67 for approximating such an arcuate shape. Comb fingers 67 have a length ranging from 25 to 190 microns and increase substantially linearly in length from the inner portion to the outer portion of the bar 66. The comb fingers 67 can have a constant width along their length or vary in width along their length. For example, the comb fingers of first comb drive assembly 46a have a constant width along their length, while the comb fingers 67 of first comb drive assemblies 46b and 46c have a proximal portion formed with a width ranging from four to 20 microns and preferably approximately 10 microns and a distal portion formed with a width less than such proximal portion and, more specifically, ranging from two to 12 microns and preferably approximately six microns. Similarly, comb fingers 67 of the first or stationary comb drives 51 of second comb drive assemblies 47a and 47b have a proximal portion which is wider than the distal portion thereof, while comb fingers 67 of the first comb drive 51 of second comb drive assembly 47c are constant in width along the length thereof.

Second or movable comb drives 52 of each of first and second comb drive assemblies 46 and 47 are spaced above substrate 41 by air gap 58. The movable comb drives 52 each have a construction similar to the related first comb drive 51. In this regard, each of the movable comb drives 52 has a radially-extending bar 71 provided with a first or inner radial portion and a second or outer radial portion that extends to outer periphery 62 of the rotary electrostatic microactuator 13. A plurality of second comb drive fingers or comb fingers 72 extend from one side of each of the bars 71 in longitudinally spaced-apart positions along the length of the bar. Second or movable comb drive fingers 72 are substantially similar to first or stationary comb drive fingers 67. Some of the second comb drive fingers have a constant width along the length thereof, for example, the second comb drive fingers of first comb drive assembly 46a and second comb drive assembly 47c, while the remaining second comb drive fingers have a width at their proximal portion which is greater than the width at their distal portion. The second comb drive fingers 72 are offset relative to the first comb drive fingers 67 so that second comb drive fingers 72 can interdigitate with the first comb drive fingers 67 when each second comb drive 52 is moved closer to the respective first comb drive 51.

Bars 71 of second comb drive 52 are interconnected to form movable structure 42. In this regard, bar 71 of first comb drive assembly 46a and bar 71 of second comb drive assembly 47a are joined together at their outer radial end portions by an interconnecting member or link 76. Similarly, bar 71 of first comb drive assembly 46c and bar 71 of second comb drive assembly 47c are joined at their outer radial end portions by a link 76. The bars 71 of second comb drive assembly 47a and first comb drive assembly 46c are joined together at their inner radial end portions by mirror holder 43, which is preferably centered on radial centerline 63 adjacent axis of rotation 48. As such, the inner radial portions of such bars 71 are included within the means of microactuator 13 for coupling rotatable member or mirror holder 43 to second comb drives 52. Bars 71 of first comb drive assembly 46b and second comb drive assembly 46b are joined together by an interconnecting arcuate member 77 at the respective outer radial end portions.

First and second comb drive assemblies 46 and 47 have a length ranging from 200 to 2000 microns and preferably approximately 800 microns. The first and second comb drive assemblies do not all have to be of equal length. As shown in FIG. 3, first comb drive assembly 46b and second comb drive assembly 47b are substantially smaller in length than the remaining comb drive assemblies 46 and 47. At least one and as shown all of first and second comb drive assemblies 46 and 47 are not centered along a radial extending outwardly from axis of rotation 48. In this regard, the distal ends of the first and second comb fingers 67 and 72 of each comb drive assembly 46 and 47 are aligned along an imaginary line that does not intersect axis of rotation 48 and, instead, is spaced-apart from the axis of rotation 48. Each of the first and second comb drive assemblies 46 and 47 thus resembles a sector of a semicircle that is offset relative to a radial of such semicircle. It should nonetheless be appreciated that some or all of the first and second comb drive assemblies can be centered along a radial extending through axis of rotation 48.

Means including first and second spaced-apart springs 53 and 54 is included within microactuator 13 for movably supporting structure 42 over substrate 41 and for providing radial stiffness to the second comb drives 52 and mirror holder 43. Springs 53 and 54 are symmetrically disposed about radial centerline 63 and can have a length which approximates the length of at least some of first and second comb drive assemblies 46 and 47. A bracket member or anchor 78 is provided along base 61 of microactuator 13 for coupling first and second springs 53 and 54 to the substrate 41. The inner radial end portions of first and second springs 53 and 54 are preferably joined to anchor 78 at axis of rotation 48. Each of the springs 53 and 54 is preferably a single beam-like member having a first or inner radial end portion joined to anchor 78, so as to be coupled to substrate 41, and a second or outer radial end portion joined to a link 76, so as to be coupled to second comb drives 52 and the remainder of removable structure 42. First spring 53 extends radially outwardly from anchor 78 between movable bars 71 of first comb drive assembly 46a and second comb drives assembly 47a and second spring 54 extends radially outwardly from the anchor between movable bars 71 of first comb drive assembly 46c and second comb drive assembly 47c. The springs 53 and 54 each have a width ranging from one ten microns and preferably approximately four microns.

Second comb drives 52 of first and second comb drive assemblies 46 and 47 are each movable in a direction of travel about axis of rotation 48 between a first or rest position, as shown in FIG. 3, in which the comb fingers 67 and 72 are not substantially fully interdigitated and a second position (not shown) in which the comb fingers 67 and 72 are substantially interdigitated. Comb drive fingers 67 and 72 can be partially interdigitated, as shown with first comb drive assemblies 46b and 46c and second comb drive assemblies 47a and 47b, or fully disengaged and thus not interdigitated, as shown with first comb drive assembly 46a and second comb drive assembly 47b, when the second comb drives 52 are in their first position. When in their second position, movable comb drive fingers 72 of the second comb drives 52 extend between respective stationary comb drive fingers 67 of the first comb drives 51. Movable comb drive fingers 72 approach but preferably do not engage stationary bar 66 and similarly stationary comb drive fingers 67 approach but preferably do not engage movable bar 71.

Each of the second comb drives 52 is also movable from its first position in an opposite second direction to a third position, not shown, in which comb drive fingers 67 and 72 are spaced apart and fully disengaged. When each second comb drive 52 of the first comb drive assemblies 46 is in its second position, each second comb drive 52 of the second comb assemblies 47 is in its third position. Similarly, when each second comb drive 52 of the second comb drive assemblies 47 is in its second position, each second comb drive 52 of the first comb drive assemblies 46 is in its third position.

Each of stationary and movable comb drive fingers 67 and 72 is optionally inclined relative to respective bars 66 and 71. That, is each such comb finger is joined to its respective bar at an oblique angle, as disclosed in U.S. patent application Ser. No. 09/755,743 filed Jan. 5, 2001, as opposed to a right angle. The inclination angle at which each comb drive finger 67 and 72 is joined to its respective bar 66 and 71, measured from a line extending normal to the bar, can range from zero to five degrees and is preferably approximately three degrees.

Each movable comb drive finger 72 is further optionally offset relative to the midpoint between the adjacent pair of stationary comb drive fingers 67 between which such movable comb drive finger interdigitates when the second comb drive 52 is electrostatically attracted to the first comb drive 51, also as disclosed in U.S. patent application Ser. No. 09/755,743 filed Jan. 5, 2001. When each movable comb drive finger 72 moves to its second position between the adjacent pair of stationary comb drive fingers 67, the movable comb drive finger becomes centered relative to the midpoint between the adjacent pair of stationary comb drive fingers 67. The offset and inclination of stationary and movable comb drive fingers 67 and 72 serves to accommodate the slight radially-inward shift of the movable comb drive 52 , resulting from the deflection and foreshortening of first and second springs 53 and 54, when movable structure 42 moves from its first position in which springs 53 and 54 are in a straightened position, as shown in FIG. 3, to its second position in which springs 53 and 54 are bent or deflected.

First and second pointers 81 extend radially outwardly from respective links 76 for indicating the angular position of movable structure about axis of rotation 48 on first and second scales 82 provided on substrate 41.

Electrical means is included for driving second or movable comb drives 52 between their first and second positions. Such electrical means can include a controller and voltage generator 86 electrically connected to a plurality of electrodes provided on substrate 41. Such electrodes include a ground or common electrode 87 electrically coupled to anchor 78 and thus second or 25 movable comb drives 52, one or more first drive electrodes 88 coupled to the first or stationary comb drives 51 of first comb drive assemblies 46, and one or more second drive electrodes 89 coupled to the first or stationary comb drives 51 of second comb drive assemblies 47. A metal layer (not shown) made from aluminum or any other suitable material is provided on the top surface of top wafer 56 for creating the electrodes and any leads relating thereto. Electrodes 8730 89 are electrically coupled to internal bonding pads 37 by any suitable means such as wires (not shown) and are thus electrically coupled to appropriate pins 36. Controller and voltage generator 86, typically not a part of package 9, is electrically coupled to the pins 36 and is shown schematically in FIG. 3.

Means in the form of a closed loop servo control can be included for monitoring the position of movable comb drives 52 and thus mirror holder 43. For example, controller 86 can determine the position of the movable comb drives 52 about axis of rotation 48 by means of a conventional algorithm included in the controller for measuring the capacitance between comb drive fingers 72 of the movable comb drives 52 and comb drive fingers 67 of the stationary comb drives 51. A signal separate from the drive signal to the comb drive members can be transmitted by controller 86 to the microactuator 13 for measuring such capacitance. Such a method does not require physical contact between the comb drive fingers 52 and 67. Alternatively, where microactuator 13 is used in an optical system, as in the instant application, a portion of the output optical energy coupled into the output fiber can be diverted and measured and the drive signal from the controller 86 to the microactuator 13 adjusted so that the measured optical energy is maximized.

The optical microswitch of package 9 is similar to the optical microswitch disclosed in U.S. patent application Ser. No. 09/464,361 filed Dec. 15, 1999. In this regard, a micromachined mirror 96 is coupled to microactuator 13 and extends out of the plane of the microactuator. More specifically, micromirror 96 is secured to microactuator 13 by a post preferably formed integral with the mirror 96 and micromachined separately from microactuator 13. The post is joined at its base to mirror holder 43 by any suitable means such as an adhesive. Micromirror 96 has a reflective face or surface 97 and is rotatable by microactuator 13 about axis of rotation 48.

Microactuator 13 is secured to bottom surface 27 of body 17 adjacent forward surface 26 by an adhesive or any other suitable means. Micromirror 96 extends substantially parallel to forward surface 26 and mirror face 97 faces the forward surface 26. An optically clear window can be provided in body 17 so that laser light can pass through front surface 22 and forward surface 26 and thus impinge on mirror face 97. Although a clear glass window can be utilized to couple the laser light into package 9, in the one preferred embodiment shown in FIGS. 1 and 2 a collimating lens such as a GRIN lens 98 is carried by body 17 to collimate the optical beam and to provide a fluid-tight seal between internal chamber 12 and the environment outside package 9. GRIN lens 98 is soldered or otherwise secured inside a tube formed integral with a Kovar end plate 101 brazed to front surface 22 of package body 17. GRIN lens 98 has an outer surface 99 and an inner surface (not shown) that is spaced from mirror face 97 a distance equal to the focal distance of the lens 98.

A damping material or fluid is disposed within internal chamber 12 for damping the movement of movable structure 42 during the operation of optical switching package 9. One or more filling holes 103 are provided in body 17 and/or lid 31 for introducing the damping the fluid into chamber 12. As shown, a plurality of two filling holes 103 extend through body 17 and onto bottom surface 27. Filling holes 103 are preferably gold plated. In another embodiment of (not shown), a Kovar or other metal tube is provided in body 17 adjacent to GRIN lens 98. The tube is accessible at front surface 22 of package body 17 for filling internal chamber 12.

Damping fluid 16 is particularly suited for damping the movement of movable structure 42 and thus micromirror 96 carried thereby at the resonant frequency of such structures relative to the stationary structure of microactuator 13. Such resonant frequency is a function of the mechanical quality factor Q of the microactuator 13. If the dominant dissipation mechanism between stationary and movable comb drives or electrodes 51 and 52 is Couette flow, then such mechanical quality factor Q is inversely proportional to the viscosity of the damping fluid.

Although any suitable damping material can be utilized, a damping fluid is preferred. The viscosity of the damping fluid is chosen such that the mechanical quality factor Q of the microactuator 13, when immersed within the damping fluid in internal chamber 12, preferably ranges from 0.3 to 20 and more preferably ranges from 0.5 to three. When the mechanical quality factor Q is at such levels, undesired spikes in the rotational motion of the movable structure 42 of microactuator 13 are minimized.

A high-viscosity gas, a low-viscosity fluid or any suitable energy dissipating material can be used for damping microactuator 13. Preferred damping fluids have a viscosity greater than the viscosity of air. The viscosity of the damping fluid can be chosen over a range of at least four orders of magnitude, given reasonable ability to select the amount of damping required for a given structure of the actuator. In one preferred embodiment, the damping fluid is a liquid.

The damping fluid is preferably a dielectric fluid, that is a substantially insulating fluid, and is typically a dielectric liquid. Since the force produced by an electrostatic actuator is proportional to the magnitude of the dielectric constant of any fluid filling the gap between the electrodes of the actuator, in this instance the gap between stationary comb drive fingers 67 and movable comb drive fingers 72, an increase in force of the microactuator can be provided by increasing the dielectric constant of the damping fluid. The relative dielectric constant of many dielectric fluids is many times greater than the dielectric constant of air, thus providing the same increase in force from a similar microactuator immersed in air for a given voltage and electrode geometry. The dielectric constant of the damping fluid is preferably greater than two and more preferably ranges from three to ten.

The damping fluid can be either a nonpolar fluid or a polar fluid. The dielectric constant of a fluid tends to increase with increasing polarity of the fluid. Hence, it can be advantageous to provide damping fluids, preferably damping liquids, with higher polarities. In another preferred embodiment, the damping fluid can be a super-critical fluid at the operational temperature of microactuator 13 and at the pressure in internal chamber 12 during such operation.

At least one optional drag-inducing member can be carried by movable structure 42 for producing drag on the movable structure as it moves between its first and third positions. In this regard, at least one and as shown a plurality of drag-inducing members or fins 106 are provided on arcuate member 77 ofmovable structure 42. Additional fins 106 are also provided at the outer radial end portions of movable bars 71 of first comb drive assembly 46b and second comb drive assembly 47b. Stationary drag-inducing members or fins 107 can optionally be mounted on substrate 41 in the vicinity of movable fins 106. As shown in FIG. 3, stationary fins 107 are disposed adjacent the movable fins 106 on arcuate member 77 and the outer radial end portions of such movable bars 71 discussed above. Fins 106 and 107 preferably extend substantially perpendicular to the direction of travel of movable structure 42 and are preferably disposed in the vicinity of each other. It is advantageous to minimize the mechanical clearance of fins 106 and 107 so as to maximize their effect. Such non-interdigitated fins can be provided which have sufficient clearance to be fabricated, yet as they move pass each other during motion of movable structure 42 the gap between such fins is less than the when-fabricated clearance between the fins. It should be appreciated that fins 106 and/or 107 can be provided at other locations on microactuator 13 and be of other shapes and sizes and be within the scope of the present invention. Furthermore, in other embodiments of the invention, such damping fins can be fabricated in structures which are not part of the electrostatic drive mechanisms of microactuator 13 such that a voltage difference does not exist between the movable and stationary fins when microactuator 13 is being operated.

In operation and use, after fabrication of microactuator 13 and the attachment of micromirror 96 to mirror holder 43, the microactuator 13 is attached to bottom surface 27 in the manner discussed above. Lid 31 is attached to body 17 by means of sealing ring 28. Chamber 12 is filled with the appropriate damping fluid by means of filling holes 103 and the chamber 12 is then sealed by press fitting a plug, or soldering or welding a lid, to the exterior end of the filling holes 103. In the embodiment where a metal fill tube is provided adjacent GRIN lens 98, chamber 12 is filled by means of such tube with the damping fluid. The tube is then crimped or welded shut to contain the damping fluid within package 9.

Once package 9 is plugged into place or otherwise mounted into a suitable optical system, for example adjacent the ends of one or more optical fibers in a telecommunication system, and electrically coupled by means of pins 36 to a suitable controller and voltage generator 86, the package 9 can be used for switching laser light between the one or more optical fibers in the manner disclosed in U.S. patent application Ser. No. 09/464,373 filed Dec. 15, 1999 (Our file No. A-68184), the entire content of which is incorporated herein by this reference. As part of this operation, mirror holder 43 can be rotated in opposite first and second directions of travel about axis of rotation 48 by controller 86. Suitable voltage potentials to first and second drive electrodes 88 and 89 can range from 20 to 250 volts and preferably range from 60 to 180 volts. Microactuator 13 is capable of +/− six degrees of angular rotation, that is a rotation of six degrees in both the clockwise and counterclockwise directions for an aggregate rotation of twelve degrees, when such drive voltages are utilized. Mirror holder 43, and thus micromirror 96, can be stopped and held at any location in such range of motion.

The utilization of a damping fluid within package 9 serves to damp the resonant modes of the microactuator 13. The rotation of movable structure 42 about axis of rotation 48 was studied as a function of the frequency of operation of microactuator 13. The graph in FIG. 5 plots the normalized rotation of movable structure of 42 as a function of frequency for several test cases. As set forth therein, an initial test of microactuator 13 was performed utilizing air as a damping fluid. The mechanical quality factor Q of microactuator 13 was calculated to be approximately 20 when operated in air, which has a viscosity at room temperature of approximately 190 uP. The microactuator 13 had an in-plane fundamental resonant frequency of 700 Hz and an out-of-plane resonant frequency of 2350 Hz when so tested in air. The increased vibration amplitude at integer sub-harmonics of these resonances is due to the nonlinear nature of the drive force.

Microactuator 13 was then tested using several damping fluids having a viscosity greater than air. Specifically an immersion liquid sold by Cargille Laboratories of Cedar Grove, N.J., known as Cargille immersion liquid, Formula Code 4501, and diethylbenzene (DEB). The Cargille immersion liquid had a viscosity of 1.4 cP, as measured by a falling ball viscometer, and the diethylbenzene had a measured viscosity of 0.6 cP. Couette flow would predict a mechanical quality factor Q for microactuator 13 of approximately 0.25 in the Cargille fluid and a mechanical quality factor Q of approximately 0.60 in diethylbenzene, in each case neglecting the change in mass due to fluid motion. The resonant frequency for the Cargille fluid was calculated to be 375 Hz with a mechanical quality factor Q of 0.22 and the resonant frequency for the diethylbenzene was calculated to be 349 Hz with a mechanical quality factor of 0.66. After such test, package 9 was drained and microactuator or motor 13 was rinsed in isopropyl alcohol and dried. The frequency response of microactuator 13 was then measured again in air. As shown in FIG. 5, the utilization of such damping fluids in package 9 served to reduce the mechanical quality factor Q to an acceptable level and thus damp the microactuator 13 at its resonant modes.

As can be seen, when damping fluids with sufficient viscosity are utilized, the drag induced by the relative motion between the comb drive fingers 67 and 72 is sufficient to substantially damp the resonance of microactuator 13. In addition, since desired damping fluids are also denser than air, when movable structure 42 is immersed in the fluid, the inertial forces on the movable structure are reduced due to the buoyancy of the movable structure in the fluid. For example, the inertial forces on movable structure 42 made from silicon, which has a density of approximately 2.3 gm/cc, are reduced by approximately eighty percent when the structure 42 is immersed in a damping fluid such as perfluorodecalin having a density of approximately 1.92 gm/cc.

Other suitable damping fluids, not identified on FIG. 5, include neon, d-limonene, octamethyltrisiloxane, t-octylamine and ethoxy-nonafluorobutane. Neon, which has a viscosity at room temperature of approximately 315 uP, compared to the 190 uP viscosity of air at room temperature, is particularly suitable if only a small increase in damping is required for microactuator 13 or another micromechanical device. If a small decrease in damping is desired, for example with parts where squeeze-film damping predominates, the use of hydrogen with a viscosity of approximately 90 uP is suitable.

The relative dielectric constant of the fluid was calculated by taking the square of the ratio of voltages required to achieve 50% of the full deflection at low frequency. The Cargille immersion liquid had a dielectric constant e of 2.44 and diethylbenzene had a dielectric constant of 3.45. The Cargille immersion liquid thus provided an increase in microactuator force of approximately 2.44 and diethylbenzene provided an increase in microactuator force of approximately 3.45, in each case, relative to the force produced by microactuator 13 when operated in air.

Optional fins 106 and 107 provide additional drag on movable structure 42 so as to further damp the resonant modes of the movable structure 42 during operation of microactuator 13 and optical package 9. As movable fins 106 pass stationary fins 107, increased fluid flow is provided in internal chamber 12. Specifically, fins 106 and 107 increase the turbulence of the fluid flow within chamber 12 and thus increase the drag on movable structure 42.

Although the fluid-damped microactuator of the present invention has been shown as being part of a optical microswitch, it should be appreciated that a fluid-damped microactuator can be provided in a variety of other optical components. Further, a fluid-damped microactuator of the present invention can be utilized in other than telecommunications systems. For example, such microactuators can be utilized in data storage systems, for example magneto optical data storage systems. It should also be appreciated that the drag-inducing members of the present invention can be used in undamped microactuators, for example microactuators or other microdevices operated in air. The damping techniques disclosed herein can be used in combination with the damping techniques disclosed in U.S. patent application Ser. No. ______ filed contemporaneously herewith (Our file No. A-70529), the entire content of which is incorporated herein by this reference. In addition, the damping fluids hereof can also be used with devices other than actuators.

As can be seen from the foregoing, a microactuator has been provided which is damped so as to control the resonant modes of the microactuator. The microactuator is damped with a fluid other than air and is preferably damped with a dielectric fluid. Nonpolar or polar fluids can be used as the damping fluid. The damping fluid can be any suitable liquid. The damped microactuator hereof is suited for moving structures throughout a broad range of motion to a variety of locations, and holding such structures at such locations, particularly in the presence of vibration or other disturbances at or near the resonance frequency.

What is claimed is:

1. A damped micromechanical device comprising a housing provided with an internal fluid-tight chamber, an electrically-driven microactuator disposed in the fluid-tight chamber and having a movable structure capable of being moved between first and second positions at a resonant frequency and a damping fluid disposed in the fluid-tight chamber for damping the movement of the movable structure at the resonant frequency.

2. The device of claim 1 wherein the damping fluid has a viscosity greater than the viscosity of air.

3. The device of claim 1 wherein the damping fluid is a liquid selected from the group consisting of polar liquids and nonpolar liquids.

4. The device of claim 3 wherein the liquid is a dielectric liquid.

5. The device of claim 1 wherein the damping fluid is a super-critical fluid.

6. The device of claim 1 wherein the microactuator is an electromagnetic micro actuator.

7. The device of claim 6 wherein the microactuator is an electrostatic microactuator.

8. The device of claim 7 wherein the microactuator includes a substrate, at least one comb drive assembly having a first comb drive member mounted on the substrate and a second comb drive member overlying the substrate, at least one spring member having a first end portion coupled to the substrate and a second end portion coupled to the movable structure, the movable structure including the second comb drive member and the second comb drive member being movable at the resonant frequency between first and second positions relative to the first comb drive member.

9. The device of claim 8 wherein the first comb drive member has a plurality of first comb drive fingers and the second comb drive member has a plurality of second comb drive fingers, the second comb drive fingers being not substantially fully interdigitated with the first comb drive fingers when the second comb drive member is in the first position and the second comb drive fingers being substantially fully interdigitated with the first comb drive fingers when the second comb drive member is in the second position.

10. The device of claim 8 wherein the damping fluid has a dielectric constant greater than the dielectric constant of air so as to enhance the electrostatic forces between the first and second comb drive members.

11. The device of claim 8 further comprising at least one drag-inducing member carried by the movable structure for producing drag on the movable structure as it moves between its first and second positions.

12. The device of claim 11 wherein the at least one drag-inducing member is a fin.

13. The device of claim 1 further comprising at least one drag-inducing member carried by the movable structure for producing drag on the movable structure as it moves between its first and second positions.

14. The device of claim 1 wherein the microactuator has a mechanical quality factor Q that ranges from 0.3 to 20 when operated in the damping fluid.

15. The device of claim 14 wherein the microactuator has a mechanical quality factor Q that ranges from 0.5 to 3 when operated in the damping fluid.

16. A damped micromechanical device comprising a housing provided with an internal fluid-tight chamber, an electrostatic microactuator disposed in the fluid-tight chamber and having a stationary structure and a movable structure capable of being moved between first and second positions at a resonant frequency relative to the stationary structure and a dielectric liquid disposed in the fluid-tight chamber for damping the movement of the movable structure at the resonant frequency and enhancing the electrostatic force between the stationary structure and the movable structure.

17. The device of claim 16 wherein the microactuator includes a substrate, at least one comb drive assembly having a first comb drive member mounted on the substrate and a second comb drive member overlying the substrate, at least one spring member having a first end portion coupled to the substrate and a second end portion coupled to the movable structure, the movable structure including the second comb drive member and the second comb drive member being movable at the resonant frequency between first and second positions relative to the first comb drive member.

18. The device of claim 17 wherein the first comb drive member has a plurality of first comb drive fingers and the second comb drive member has a plurality of second comb drive fingers, the second comb drive fingers being not substantially fully interdigitated with the first comb drive fingers when the second comb drive member is in the first position and the second comb drive fingers being substantially fully interdigitated with the first comb drive fingers when the second comb drive member is in the second position.

19. The device of claim 16 wherein the liquid is selected from the group consisting of a polar liquid and a nonpolar liquid.
